(19) United States
(12) Patent Application Publication
(10) Pub. No.: US 2008/0136285 A1
(43) Pub. Date: Jun. 12, 2008

(54) SPINDLE MOTOR, DISK DRIVE, AND METHOD OF FABRICATING A STATOR CORE

(76) Inventors: Fumio Tajima, Hitachi (JP); Teruyoshi Abe, Hitachi (JP); Motoya Ito, Hitachinaka (JP); Yoshihisa Ishikawa, Hitachinaka (JP); Masashi Kitamura, Mito (JP); Toshuyuki Ajima, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/952,170

(22) Filed: Dec. 7, 2007

(30) Foreign Application Priority Data
Dec. 12, 2006 (JP) 2006-333940

(51) Int. Cl. H02K 1/14; G11B 17/02; H02K 15/02

(52) U.S. Cl. 310/216; 29/596; 360/99.08

(57) ABSTRACT

The spindle motor has a stator and rotor. The stator has a stator core comprising a yoke and salient poles and also includes a stator coil. The stator core is formed by laminated steel sheets. The salient poles made of the steel sheets are formed by etching. The steel sheet is 0.05 to 0.30 mm thick. The steel sheet used in the present invention is preferably a silicon steel sheet having crystal particles. The iron loss and cogging torque of the inventive spindle motor are reduced.

### CLAIM OF PRIORITY

The present application claims priority from Japanese application serial No. 2006-333940, filed on Dec. 12, 2006, the content of which is hereby incorporated by reference into this application.

### FIELD OF THE INVENTION

The present invention relates to a spindle motor, a disk drive, and a method of fabricating a stator core.

### BACKGROUND OF THE INVENTION

As the amount of information to be recorded increases, hard disk drives (HDDs) and optical disk drives are demanded to be compact and lightweight, have a large storage capacity, and operate at high speed. For mobile disk drives, it is necessary to prolong a battery usage time between battery charges. One of the factors that determine the performance of the disk drive is a spindle motor. To improve this performance, it is important to achieve a spindle motor that can rotate highly efficiently and accurately at high speed.

First, a key point to meet the demand for a large storage capacity and high speed is to reduce the cogging torque of the spindle motor. An important problem to meet the demand for high efficiency and high speed is to improve the efficiency of the spindle motor, and particularly to reduce the iron loss.

Examples of spindle motors for conventional driving disks as described above are disclosed in Japanese Patent Laid-open No. 2000-235766 and No. 2000-156958, and Japanese patent No. 3551732. In all methods disclosed in these patent documents, a spindle motor is fabricated by punching thick electromagnetic steel sheets.

### SUMMARY OF THE INVENTION

To enable a disk drive to operate at high speed and to send and receive a large amount of data, it is essential to use a highly efficient spindle motor with reduced pulsating torque.

When the efficiency of the spindle motor used in an application in which high speed is demanded is increased, the reduction of iron loss is significant. The iron loss can be represented as the sum of hysteresis loss and eddy current loss.

The hysteresis loss is generated when the orientation of the magnetic domain of a core is changed by an AC magnetic field; the hysteresis loss depends on the area inside its hysteresis curve.

The stator core in the stator of a spindle motor includes a magnetic circuit formed by laminating thick electromagnetic steel sheets so as to reduce the eddy current loss.

The stator core has a complex structure including salient poles. At present, the stator core is fabricated by punching. When punching is performed, the crystal structure in a cut area of the electromagnetic steel sheet is deformed and thus its magnetic characteristics are deteriorated. Accordingly, the area inside the hysteresis curve is enlarged and the iron loss is increased. The thick electromagnetic steel sheet has the drawback that the eddy current loss is large. For this reason, it has been impossible to increase the efficiency of the spindle motor.

In the process of punching, even a large motor diameter is 10 to 30 mm at most, so precision is required. However, since the precision of punching is low, the cogging torque cannot be reduced.

The present invention addresses the problems involved in the above disclosures with the object of providing a highly efficient spindle motor for which the iron loss and cogging torque are reduced and also providing a disk drive, fabricated by the use of the spindle motor, that can store a large amount of data at high speed and can be used for a long period of time between battery charges.

The main aspect of the present invention is to prevent magnetic characteristics from being deteriorated by punching and to further improve the magnetic characteristics by processing a steel sheet through high-precision etching to reduce the thickness of the steel sheet to 0.30 mm or less.

Particularly, one aspect of the present invention is to use etching to process a silicon steel sheet, which is one type of electromagnetic steel sheet thinned to 0.30 mm or less, so as to improve the magnetic characteristics.

The spindle motor described here has a stator and a rotor; the stator has a stator core with salient poles, and stator coils wound onto each salient pole. The stator core is fabricated by laminated steel sheets. The salient poles, which are made of steel sheets, are formed by etching. The thickness of the steel sheet is 0.08 to 0.30 mm, preferably 0.10 to 0.25 mm. In a wide range, a steel sheet with a thickness down to a lower limit of 0.05 mm can be used.

If the laminated core concentration (%) of the stator core is defined to be “thickness (mm) of steel material (steel sheet)×number of sheets÷height of core (mm)×100”, then the laminated core concentration is preferably 90.0% to 99.9%.

The present invention can provide a highly efficient spindle motor for which the iron loss and cogging torque are reduced, and can also provide a disk drive, fabricated by the use of the spindle motor, that can store a large amount of data at high speed and can be used for a long period of time between battery charges.

### BRIEF DESCRIPTION OF THE DRAWINGS

FIG. 1 is a drawing showing the structure of a spindle motor in a first embodiment of the present invention.

FIG. 2 is a drawing showing a hard disk drive (HDD) in the first embodiment of the present invention.

FIG. 3 is a graph indicating the relation between the thickness of an electromagnetic steel sheet and the iron loss.

FIG. 4 is a graph indicating the relation between the content of silicon in a silicon steel sheet and the iron loss.

FIG. 5 shows typical cross sections on which etching has been performed.

FIG. 6 is a drawing showing a typical cross section on which punching has been performed.

FIG. 7 is a drawing showing the structure of the stator of a spindle motor in another embodiment of the present invention.

FIG. 8 is an enlarged view of the main part of the stator.

FIG. 9 is a drawing showing the structure of the stator of a spindle motor in still another embodiment of the present invention.

FIG. 10 is a drawing showing the structure of the stator of the completed spindle motor in the still another embodiment of the present invention.

### DESCRIPTION OF THE PREFERRED EMBODIMENTS

Embodiments of the present invention will be described with reference to the drawings.

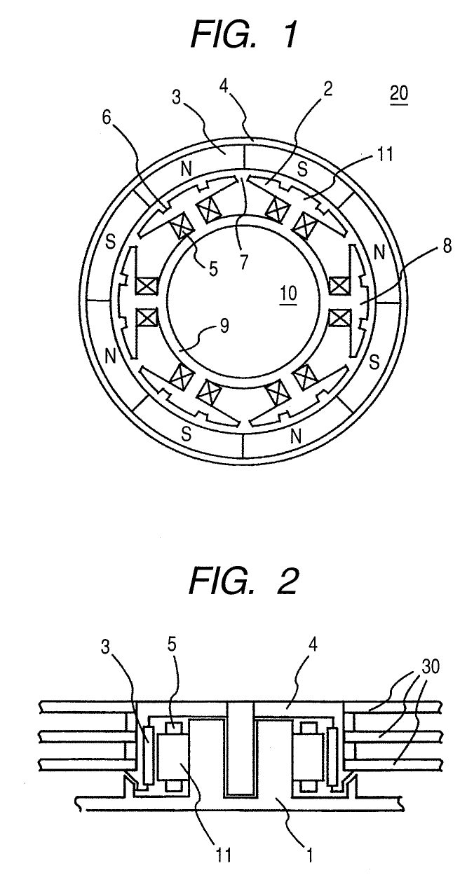

FIG. 1 shows the structure of a spindle motor in a first embodiment of the present invention. The spindle motor in the embodiment is an outer rotor type of spindle motor with a 4:3 structure in which a rotor 20 with eight poles and a stator 10 with six poles are provided. The rotor 20 has eight permanent magnets 3 and a hub 4 for fixing the permanent magnets 3. The stator 10 has six salient poles 8; each of the salient poles 8 has stator coils 5. Two compensation grooves 6 are formed on the surface of a salient pole end 2 facing a spindle motor 3 at positions near the center of the salient pole 8. A method of detecting the pole position of the permanent magnet is omitted because it is not an essential problem; for reference, there are a method in which a hall element is provided in a housing 1 and a brash-less type method in which, for example, an induced voltage generated in the stator coil 5 is detected.

In a spindle motor that lacks the compensation grooves 6, the rotor 20 has eight poles and the stator 10 has six poles, so cogging torque is generated 24 times per rotation (24 is the least common multiple of 8 and 6). Cogging torque is generated at intervals of a machine angle of 10°.

To compensate the cogging torque in this embodiment, the compensation grooves 6 are provided, which have a shape similar to the shape of a slit 7 formed between adjacent salient poles 2, at positions spaced at intervals of a machine angle of 5×(2n+1)° (n=0, 1, 2, 3 . . . ), relative to the slit 7. Due the presence of the compensation grooves 6, smooth rotation is obtained because the cogging torque is compensated by generating torque having a phase different by 180° from the phase of a spindle motor that lacks the compensation grooves 6. Specifically, since the cogging torque is generated at intervals of a machine angle of 10° due to the presence of the slits 7, if the compensation grooves 6 are formed at positions corresponding to odd-number multiples of 5°, toque can be generated which has a phase different by just 180° from the phase of the cogging torque generated due to the slits 7. That is, when the cycle of the cogging torque is Tc (Tc=360/L°, where M is the number of poles of the permanent magnet, S is the number of salient poles, and L is the least common multiple of M and S), the compensation groove 6 may be formed apart from the slit 7 by a machine angle of Tc(2n+1)/2=(360/L)×(2n+1)/2 degrees) (n is an integer).

In this embodiment, to address the problems with the mechanical strength of the salient pole end 2 and the motor efficiency, additional compensation grooves 6 are provided at positions corresponding to mechanical angles of (5×(2n+1)° (n=1, 2), that is, 15° and 25°, relative to the slit 7.

The following features can be thus obtained.

(1) When n is 1 and 2, the position of the compensation groove 6 can be brought close to the center of the salient pole 8 by a mechanical angle of about 1.7°, as compared with the position of the compensation groove 6 shown in FIG. 1.

(2) Compensation to eliminate the magnetic effect by the slit 7 is shared by the two compensation grooves 6 at positions corresponding to mechanical angles of 15° and 25°, so only a half of the magnetic effect by the slit 7 can be considered for the depth of the groove 6. That is, the depth of the groove 6 can be reduced.

From (1) and (2), the width of the core on the back of the groove can be increased. Accordingly, both reduction in the cogging torque and increase in the motor efficiency and the mechanical strength of the salient pole end 2 can be achieved.

Next, the relation between torque and the position, width W, and depth D of the compensation groove 6 will be described.

Since the cogging torque due to the slit 7 is generated in a cycle of a mechanical angle of 10°, cogging torque is generated for four cycles between adjacent slots 7 (40°). To generate compensation torque with a phase opposite to the phase of the cogging torque, an auxiliary groove may be formed at an appropriate position. In this embodiment, compensation grooves are formed at two positions near the center of the salient pole 8. The two compensation grooves 6 enable the depth D of the groove to be reduced, as compared when only one compensation groove is formed. Then, the mechanical strength of the salient pole end 2 can be secured.

When the width W of the compensation groove 6 is a width (5°) obtained by equally dividing the angle (40°) defined by adjacent slits 7 into eight segments, the depth D of the compensation groove 6 can be reduced. This is because, as with the cogging torque, when the width of the compensation torque needed to be generated for four cycles between adjacent slots 7 is one-eight the width between adjacent slits 7, the width of the groove exactly matches a half of the cycle of the compensation torque, and pulsating torque can be thus generated with the highest efficiency.

That is, when the cycle of the cogging torque is Tc (Tc=360/L°, where M is the number of poles of the rotor, S is the number of poles of the stator, and L is the least common multiple of M and S), if the width W of the compensation groove 6 is determined so that an angle of Tc/2 (=(360/L)/2°) is obtained, the compensation torque can be generated most efficiently and thereby the depth D of the compensation groove 6 can be reduced.

As described above, the use of the spindle motor in this embodiment ensures highly-efficient, smooth rotation with less speed variations, reducing noise generated by rotation. Accordingly, the spindle motor is particularly useful when used in a disk drive to rotate a CD-ROM, DVD, HD, or other disk employed in a mobile information technology device.

FIG. 2 shows an exemplary HDD in which the spindle motor that embodies the present invention is used.

The spindle motor, in this embodiment, used in the HDD is an outer rotor type of spindle motor that has been described with reference to FIG. 1 showing this embodiment. The compensation grooves 6 are formed in the salient pole end 2 of the stator core, according to the principle shown in the embodiment in FIG. 1. Accordingly, as with the spindle motor in the first embodiment, highly-efficient, smooth rotation with less speed variations can be obtained.

The shapes and dimensional tolerances of the compensation groove 6 and slit 7 significantly affect the occurrence of cogging torque. In the present invention, an auxiliary groove structure can be formed by performing etching on a thin sheet, rather than punching described in the prior art; the cogging torque generated by this auxiliary groove structure is approximately the same as the cogging torque generated through the slit 7 and has an opposite phase. Improvement in precision of the outer periphery and the like reduces cogging torque components generated by other than the slit 7 to a sufficiently low level, so the entire cogging torque can be sufficiently reduced.

In the HDD structured described above, the cogging torque is sufficiently small, so variations in the rotational speed of the disk 30 on which magnetic information is recorded can be reduced to an extremely low level, resulting in stable recording and reproduction of magnetic information, high-speed rotation, improved reliability, and an improved recording concentration.

In this example, the spindle motor has been applied to an HDD. Even when the spindle motor is applied to a CD-ROM drive or DVD drive, which use laser beams to record information on the disk 30 and reproduce the recorded information, variations in the rotational speed of the disk 30 can be reduced to an extremely low level, resulting in stable recording and reproduction of information by means of laser beams, improved reliability, and an improved recording concentration.

The stator core formed by etching in the present invention will be described below.

The stator core (sometime simply referred to below as the core) is fabricated by laminated steel sheets. Salient poles, which are made of steel sheets, are formed by etching, preferably by photoetching. The thickness of the steel sheet is 0.08 to 0.30 mm.

Of course, the entire stator core is preferably processed by photoetching to improve its magnetic characteristics and workability in all fabrication processes.

As with the stator core, the rotor core is preferably formed by etching silicon steel sheets with a thickness of 0.08 to 0.30 mm to improve its magnetic characteristics. This is because if the stator core or rotor core is formed by punching, the regular crystal structure in the steel sheet would be damaged and thereby the hysteresis loss would be increased. When the stator core or rotor core is formed by etching, the destruction of the regular crystal structure can be avoided and thereby the increase of the hysteresis loss can be avoided.

The thinner the steel sheet to be punched is, the more significant undesired shapes, such as recesses, burrs, and shear drops, at cut portions are. The hysteresis loss is then likely to increase.

Processing by punching is restricted to simple shapes formed by, for example, circles and straight lines because a die is required for punching; it is extremely difficult to manufacture a complex curved die. When the die is polished, if it has a complex curved structure, the process of polishing cannot be sufficiently performed.

To address these problems involved in punching and other types of machining, thin electromagnetic sheets can be used in order to reduce the eddy current loss. However, since the hysteresis loss is increased, it becomes difficult to reduce the iron loss.

Etching can solve these problems. Etching prevents the hysteresis loss from being increased and reduces the eddy current loss. When the stator core of a spindle motor is fabricated by etching, the entire efficiency of the spindle motor can be further increased. Typical etching is photoetching.

Etching prevents the regular crystal structure in the steel sheet from being destroyed, thereby reducing the hysteresis loss. Furthermore, since processing precision is greatly increased, improvement in spindle motor characteristics can be expected.

The width of a magnetic gap can also be processed with high precision and thereby reduction in torque pulsation or harmonic magnetic flux, reduction in magnetic resistance, or reduction in magnetic flux leak enables the characteristics and efficiency of the spindle motor to be improved.

Furthermore, since a stator core having a complex curved structure, which leads to improved characteristics and performance, can be fabricated, characteristics and performance better than those in punching can be obtained.

When, for example, the gap between the stator core and the rotor is shaped precisely, not only the efficiency can be increased but also performance improvement such as pulsation reduction and characteristic improvement can be achieved.

A specific description will be given below.

The laminated core concentration of the core in this embodiment is 90.0% to 99.9%, preferably 93.0% to 99.9%.

It is not necessarily impossible to improve the laminated core concentration by compressing the core, which has been formed by mechanically laminating steel sheets. However, this method is not preferable because the iron loss is increased. This embodiment can increase the laminated core concentration without carrying out a special process for increasing the laminated core concentration, as described below.

When the laminated core concentration of the core is increased, the magnetic flux in the core can be reduced and thereby the core of the spindle motor can be reduced.

In this case, the laminated core concentration (%) of the core is such that the thickness of the steel sheet is 0.08 to 0.30 mm, the number of steel sheets is about 20 to 100, and the height of the core is 5 to 20 mm.

The composition of the steel sheet is such that C is 0.001 to 0.060 wt %, Mn is 0.1 to 0.6 wt %, P is 0.03 wt % or less, S is 0.03 wt % or less, Cr is 0.1 wt % or less, Al is 0.8 wt % or less, Si is 0.5 to 7.0 wt %, Cu is 0.01 to 0.20 wt %, and the residual includes Fe and indispensable impurities such as an oxygen gas and a nitrogen gas.

The steel sheet is preferably a so-called silicon steel sheet, used as an electromagnetic steel sheet, that has crystal grains, the composition of which is such that C is 0.002 to 0.020 wt %, Mn is 0.1 to 0.3 wt %, P is 0.02 wt % or less, S is 0.02 wt % or less, Cr is 0.05 wt % or less, Al is 0.5 wt % or less, Si is 0.8 to 6.5 wt %, Cu is 0.01 to 0.10 wt %, and the residual includes Fe and impurities.

When the composition of this silicon steel sheet is determined to reduce the iron loss, the contents of Si and Al are important. When the ratio of Al to Si is determined for this purpose, the ratio is preferably 0.01 to 0.60; the ratio is more preferably 0.01 to 0.20.

The concentration of silicon in the silicon steel sheet can be selectively selected depending on the type of spindle motor; some spindle motors use silicon steel sheets with a silicon concentration of 0.8 to 2.0 wt %; other spindle motors use silicon steel sheets with a silicon concentration of 4.5 to 6.5 wt %.

As the content of silicon is lowered, the magnetic flux density of the silicon steel sheet is increased. In this embodiment, 1.8 to 2.2 T can be selected.

When the content of silicon is low, the ease of rolling is improved and thereby the steel sheet can be thinned. Since the thickness of the steel sheet is small, the iron loss is reduced. When the content of silicon is high, reduction in the ease of rolling can be avoided by taking a countermeasure, such as, adding silicon after rolling. In this case as well, the iron loss is reduced.

Distribution of silicon included in the silicon steel sheet may be approximately uniform in the thickness direction of the silicon steel sheet. Alternatively, to have the silicon concentration locally raised, the concentration in the interior may be higher than the concentration on the surface with respect to the thickness direction of the silicon steel sheet.

The core has an insulative film with a thickness of 0.01 to 0.2 μm between laminated steel sheets. Some spindle motors use an insulative film with a thickness of 0.1 to 0.2 μm, preferably 0.12 to 0.18 μm; other spindle motors use an insulative film with a thickness of 0.01 to 0.05 μm, preferably 0.02 to 0.04 μm.

When the thickness of the insulative film is 0.1 to 0.2 μm, the insulative film is preferably organic or inorganic. The insulative film can be made of an organic material, an inorganic material, or a hybrid material in which these materials are mixed.

When the thickness of the insulative film is 0.01 to 0.05 μm, the insulative film is preferably an oxide film. Particularly, an oxide film including iron is preferable.

That is, the insulative film can be thinned by thinning the silicon steel sheet.

To maintain insulation even after punching and increase the ease of punching itself, the thickness and composition of the insulative film formed between conventional electromagnetic steel sheets are adjusted by also considering characteristics in other than insulation such as the ease of lubrication, the degree of tight contact with the steel sheet, heat resistance in annealing after punching, and the ease of welding laminated electromagnetic steel sheets to form a core. As a result, a thickness of about 0.3 μm has been needed.

However, the thinned silicon steel sheet described in this embodiment requires that the insulative film be thinned.

This is because if an insulative film having the same thickness as in the prior art is used, the thinned silicon steel sheet would make the volume ratio of the insulative film relatively increased with respect to the volume ratio of the silicon steel sheet, and thereby there is a risk that the magnetic flux density is lowered.

However, the insulative film can be thinned for the thinned silicon steel sheet described in this embodiment.

In general, when an electromagnetic steel sheet is thinned, the insulative film needs to be thick. Unlike this concept, in this embodiment, there is no need to thin the insulative film even when the electromagnetic steel sheet is thinned. Rather, the insulative film can be thinned together with the electromagnetic steel sheet. Accordingly, the laminated core density can also be improved.

A dispersion state of silicon in the silicon steel sheet and usage conditions of the rotor need to be considered. Two cases can be selectively used according to the application; in one case, the speed in an operation region at a maximum rotational speed is low and silicon included in the silicon steel sheet is dispersed in the thickness direction of the steel sheet; in the other case, the maximum rotational speed is usually several thousands to several tens of thousands of rpm and the concentration of silicon included in the silicon steel sheet is higher on its surface than in its interior.

There is a relation between the rotational speed and the iron loss; as the rotational speed is increased, the iron loss is increased because the AC frequency of the magnetic flux is increased. The iron loss caused in a spindle motor operating at a high rotational speed tends to increase, as compared with a spindle motor operating at a low rotational speed. With this point taken into consideration, the mount of silicon to be included in the silicon steel sheet needs to be determined.

Silicon may be uniformly added to the silicon steel sheet used as the electromagnetic steel sheet by a dissolution method. Alternatively, silicon may be locally added to the electromagnetic steel sheet, particularly to its surface, by a surface improving method, ion implantation, chemical vapor deposition (CVD), or another method.

The electromagnetic steel sheet described in this embodiment is 0.08 to 0.30 mm in thickness, assuming that it is used in a core having salient poles and a yoke that constitute the stator of the spindle motor. The salient poles and yoke can be formed by etching.

In the etching process performed for an electromagnetic steel sheet with a width of 50 to 200 cm, a resist is applied to the steel sheet, the shape of the stator core is exposed and developed, the resist is removed according to the shape, processing is then performed by the use of an etching liquid, and the remaining resist is removed.

Although the tinning of the silicon steel sheet is advantageous in the reduction of iron loss, it has been considered to be impossible to thin the silicon steel sheet in an industrial scale without a significant cost rise, because rolling and punching, which is a process for punching out a core, cannot be easily performed on the silicon steel sheet. When the silicon steel sheet is used as the electromagnetic steel sheet employed in a highly efficient spindle motor that produces less torque pulsation, the thickness of the silicon steel sheet is usually 0.50 or 0.35 mm. There has been no progress toward thinned steel sheets for a long period of time.

However, the present invention has enabled the silicon steel sheet used to form a core to be thinned and thus has lowered the iron loss in an industrial scale without a significant cost rise, by employing etching rather than punching.

To reduce the iron loss, a silicon steel sheet with a low iron loss is used in this embodiment. In addition, the content of silicon is adjusted with rolling taken into consideration, the sheet is thinned with even the rolling of the silicon steel sheet taken into consideration, etching is used to form a core, the iron loss of each of the silicon steel sheets constituting the laminated core is reduced, and an insulative film formed between silicon steel sheets is considered.

In punching in which a die is used for cutting, a work hardened layer and a plastic deformed layer referring to burrs and shear drops (collectively referred to below as burrs) are formed near the cut part, causing residual distortion and residual stress. The residual stress caused during punching destructs the regularity of the arrangement of molecular magnets, that is, destructs magnetic domains, and thereby significantly increases the iron loss. An annealing process for removing the residual stress is then required. The annealing process further increases the fabrication cost of the core.

In this embodiment, a core is fabricated without performing the above punching, so there is almost no case in which a plastic deformed layer is formed and thereby no residual distortion or residual stress occur. Accordingly, the arrangement of crystal particles remains almost unchanged, preventing the arrangement of molecular magnets, that is, the arrangement of magnetic domains from being damaged and also preventing the hysteresis characteristics from being deteriorated.

The core is fabricated by laminating processed silicon steel sheets. When the occurrence of the residual distortion and residual stress in the silicon steel sheet is suppressed, the magnetic characteristics of the core can be further improved.

Accordingly, the spindle motor in this embodiment can reduce iron loss, deliver high output, and be made compact and lightweight. The electromagnetic steel sheet used in the spindle motor is superior because it has almost no burrs on edges.

A burr is one type of plastic deformed layer; since the burr sharply protrudes along the cut part, from the plane of the electromagnetic steel sheet toward to the space, the burr may break an insulative film formed on the surface of the electromagnetic steel sheet and thereby may destruct insulation between laminated electromagnetic steel sheets.

When steel sheets of this type are laminated, an unnecessary clearance is formed between laminated electromagnetic steel sheets due to burrs or the like, preventing the density of the laminated core from being increased. As a result, the magnetic flux density is lowered. The lowered magnetic flux density is an obstacle to making the spindle motor compact and lightweight.

After the electromagnetic steel sheets are laminated, the resulting core may be compressed by being pressed in the direction of its thickness to crush the burrs and increase the laminated core density. In this method, however, the residual stress is increased by the compression, increasing the iron loss. Another problem is that insulation may be destroyed by the burrs.

The core described in this embodiment has almost no burrs, so there is no need to press and compress the core and thus the laminated core density can be increased. Insulation destruction does not occur. Accordingly, the iron loss can be reduced.

When the silicon steel sheet employed as the electromagnetic steel sheet used to fabricate the core includes 6.5 wt % of silicon, the iron loss is theoretically minimized. When the content of silicon is increased, however, the ease of rolling and punching is significantly reduced. Accordingly, to prioritize rolling and punching at the sacrifice of a little increase in iron loss, it is dominant that the content of silicon in the silicon steel sheet is about 3.0 wt %.

The silicon steel sheet described in this embodiment can be thinned down to 0.3 mm or less. Therefore, even when the content of silicon is 2.0 wt % or less, the iron loss remains low.

In the manufacturing of conventional silicon steel sheets 0.3 mm or less thick, special processes of rolling and annealing have been needed. The silicon steel sheet described in this embodiment does not need these processes, so the cost to manufacture the tinned silicon steel sheet can be reduced. Since the fabrication of the core does not require punching, the fabrication cost can be further reduced.

In addition to the silicon steel sheet, which is the main material of the core, an extremely expensive amorphous material, the use of which is limited to special applications, is known as an extremely thin electromagnetic material. The amorphous material involves a special process in which the amorphous material is fabricated as a foil by rapidly solidifying a melted metal, so it is possible to fabricate an extremely small amount of very thin amorphous material with a thickness of about 0.05 mm or less and a width of about 300 mm. However, it is considered to be impossible to fabricate amorphous materials thicker and wider than this amorphous material in an industrial scale.

Amorphous materials of this type cannot be used as the dominant core material, because: they are hard, fragile, and too thin and thus they cannot be punched; their flux density is low due to restricted chemical components; and the like.

Unlike these amorphous materials, the electromagnetic steel sheet described in this embodiment has crystal particles.

The electromagnetic steel sheet in this embodiment satisfies all of reduction in thickness, which is advantageous for reducing the iron loss, reduction in distortion, high output, improvement in dimensional precision, which is advantageous for a compact and lightweight design, and improvement in laminated core density, which is advantageous for obtaining a high magnetic flux density.

That is, according to this embodiment, a core that can achieve a low iron loss, high output, and compact and lightweight design can be provided.

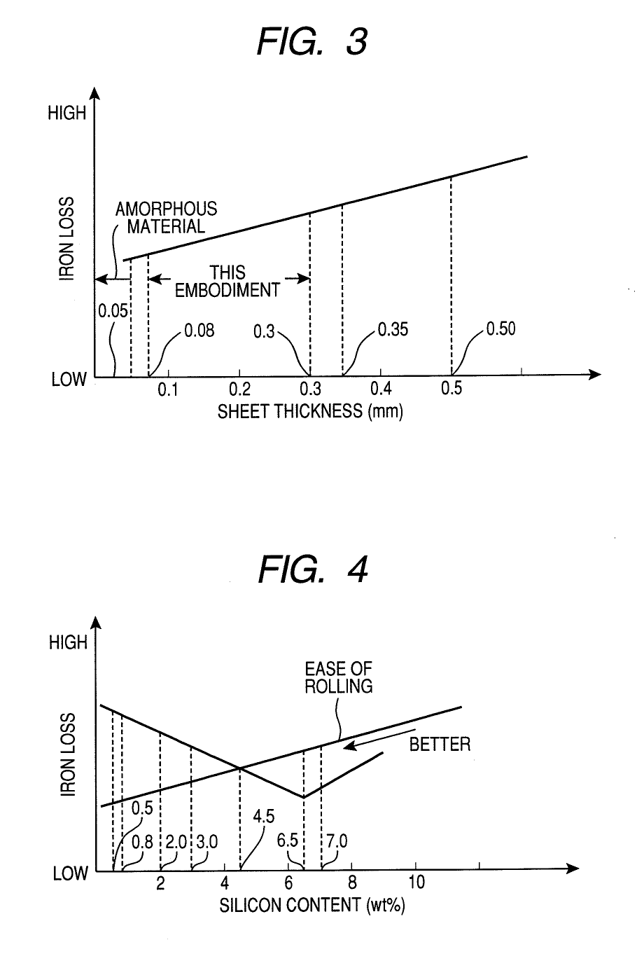

FIG. 3 is a graph indicating the relation between the thickness of the electromagnetic steel sheet and the iron loss.

It is found from FIG. 3 that as the thickness of the electromagnetic steel sheet increases, the iron loss increases.

Two types of silicon steel sheets that are generally used are 0.50 and 0.35 mm thick so that they can be easily extended by rolling or punched.

These two types of thick silicon steel sheets, which are widely used in the manufacturing of cores, need to undergo rolling and annealing to reduce the iron loss. To further thin these silicon steel sheets, the rolling and annealing must be repeated; the number of repetitions depends on the shape and size of the core. Accordingly, to thin the generally used silicon steel sheets, it is necessary to add special processes of rolling, annealing, etc to their fabrication, increasing the cost.

For the core described in this embodiment, the fabrication cost can be reduced and problems with the processing of the core can be solved, so mass production in an industrial scale is possible.

The silicon steel sheet used in this embodiment is 0.08 to 0.30 mm thick. A silicon steel sheet 0.1 to 0.2 mm thick is preferably used to shape it into a core through etching.

FIG. 3 also shows the range of thicknesses of amorphous materials for reference purposes. The amorphous material involves a special process in which the amorphous material is fabricated as a foil by rapidly solidifying a melted metal, so it is suitable to the manufacturing of very thin sheets with a thickness of about 0.05 mm or less. Amorphous materials thicker than these sheets are hard to manufacture because they cannot be rapidly cooled with ease. The widths of manufacturable materials are also limited to about 300 mm. These limitations and the special processes extremely increase the manufacturing cost.

As for the magnetic characteristics of the amorphous materials, the iron loss is low, but the magnetic flux density is low because limited chemical components are used so as to carry out rapid solidification.

In this embodiment, a silicon steel sheet having crystal particles rather than these amorphous materials is used.

Next, a typical process for fabricating a silicon steel sheet will be described.

A steel sheet is fabricated by using a material that can be used to fabricate an electromagnetic steel sheet. For example, the composition of the steel sheet material used is such that C is 0.005 wt %, Mn is 0.2 wt %, P is 0.02 wt %, S is 0.02 wt %, Cr is 0.03 wt %, Al is 0.03 wt %, Si is 2.0 wt %, Cu is 0.01 wt %, and the residual includes Fe and a small amount of impurities.

This steel sheet material undergoes continuous forging, hot rolling, continuous annealing, acid cleaning, cold rolling, and continuous annealing so that a silicon steel sheet with a width of 50 to 200 cm, particularly with a width of 50 cm and a thickness of 0.2 mm in this embodiment is fabricated.

To reduce the iron loss, 4.5 to 6.5 wt % silicon may be further included in the surface of the fabricated silicon steel sheet.

The surface of the fabricated silicon steel sheet is then coated with an insulative film, made of organic resin, with a thickness of 0.1 μm. This completes the fabrication of the silicon steel sheet.

An oxide film with a thickness of 0.01 to 0.05 μm may be formed without using this special process of coating the silicon steel sheet with the insulative film.

Incidentally, during the core fabrication, the process of coating the silicon steel sheet with the above-mentioned insulative film is preferably carried out after the etching process.

The silicon steel sheet is shaped into a flat sheet, coil, or roll.

Next, a typical core fabricating process will be described.

Preprocessing is performed on the fabricated silicon steel sheet and a resist is applied to the preprocessed steel sheet. A mask is used to form a stator core shape and the shape is exposed and developed. The resist is removed according to the shape. An etching liquid is then used for processing. Upon the completion of the processing by the use of the etching liquid, the remaining resist is removed to fabricate a silicon steel sheet having the desired stator core shape. In this fabrication, photoetching, for example, is effective. Another effective method is to form minute holes by using a metal mask.

A plurality of silicon steel sheets having the stator core shape formed as desired are laminated. The laminated silicon steel sheets are fixed by, for example, welding to form a core. Welding with low heat input, such as fiber laser welding, is preferably performed.

When a salient pole shape is formed by etching, a stator core with a desired shape can be fabricated with extremely high processing precision, for example, with only an error of +10 μm or less, preferably ±5 μm or less.

When error is represented as circularity, it is 30 μm or less, preferably 15 μm or less, more preferably 10 μm or less. Incidentally, circularity is a degree of deviation from a geometric circle of a circular part. Specifically, when the circular part is placed between two geometrical concentric circles so that the area between the two circles is minimized, circularity is a difference between the radii of the two circles.

FIG. 4 is a graph indicating the relation between the content of silicon in the silicon steel sheet and the iron loss.

As seen from FIG. 4, the silicon steel sheet including 6.5 wt % of silicon has the least iron loss. However, when a silicon steel sheet includes as much as 6.5 wt % of silicon, rolling cannot be performed easily on the silicon steel sheet, making it difficult to fabricate the silicon steel sheet to a desired thickness. This is because the ease of rolling is likely to decrease as more silicon is included in the electromagnetic steel sheet. Accordingly, the silicon steel sheet including 3.0 wt % of silicon is used with a tradeoff between the iron loss and the ease of rolling taken into consideration.

In this embodiment, the iron loss of the silicon steel sheet is reduced by reducing its thickness, so that an effect of the content of silicon in the silicon steel sheet on the iron loss is reduced.

Accordingly, the ease of rolling performed on the silicon steel sheet described in this embodiment is improved, and the flexibility of the content of silicon in the silicon steel sheet, which largely affects the iron loss, is increased. The content of silicon in the silicon steel sheet can then fall within the range of 0.5 to 7.0 wt %. It is also possible to use significantly different contents, 0.8 to 2.0 wt % and 4.5 to 6.5 wt %, enabling silicon steel sheets to be selectively used according to the specifications of the core or the application of the spindle motor.

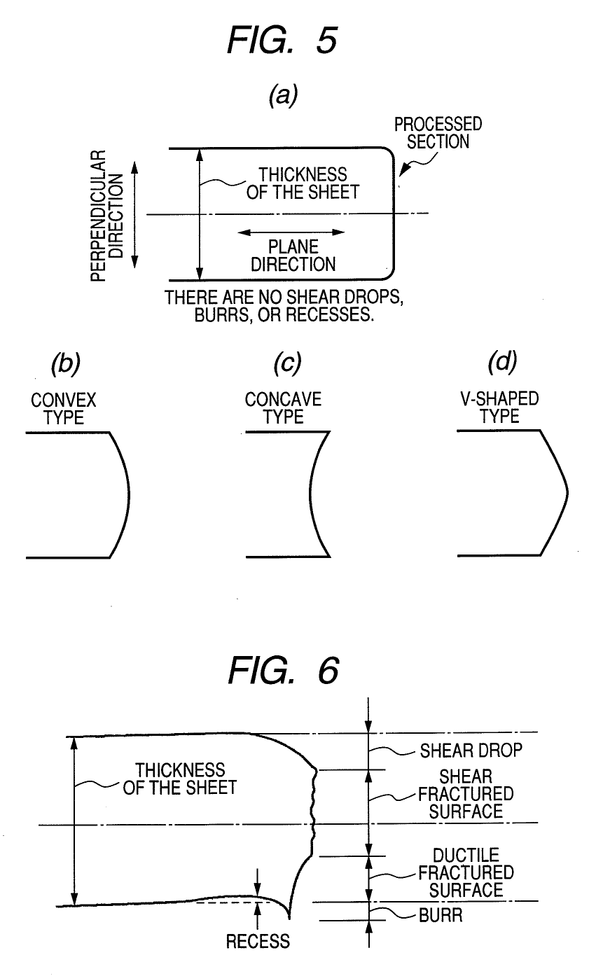

FIGS. 5A to 5D show typical cross sections on which etching has been performed.

After etching has been performed on the silicon steel sheet, there are no plastic deformed layers such as burrs near the processed cross section that are molted by an acid liquid, as shown in FIG. 5A. A processed cross section approximately perpendicular to the plane of the silicon steel sheet can be formed.

Cutting-edge photoetching enables control of the shapes of melted parts as shown in FIGS. 5B to 5D. That is, it is possible to form a prescribed taper as well as a concave and convex in a direction perpendicular to the thickness direction of the silicon steel sheet.

For the silicon steel sheet photoetched as described above, essentially no residual stress due to the photoetching occurs, almost no plastic deformed layers are formed, and the amount of plastic deformation in the thickness direction of the silicon steel sheet is almost 0. The amount of plastic deformation caused by the photoetching near the processed cross section is almost 0.

The shape of the photoetched cross section of the silicon steel sheet can be controlled, so it is possible to form a cut cross section for which the residual stress due to the photoetching is almost 0 and the amount of plastic deformation near the cut cross section is almost 0.

When this type of etching is used, the minute crystal structure of the silicon steel sheet, mechanical characteristics, and front surface can also be applied to the core in their optimum states. It is also possible to optimize the magnetic characteristics of the core by considering the anisotropy of the crystal structure of the silicon steel sheet and the anisotropy of the magnetic characteristics based on that anisotropy.

FIG. 6 shows a typical cross section on which punching has been performed.

After punching has been performed on the silicon steel sheet, shearing stress during plastic processing causes significant deformation near the processed cross section; burrs, shear drops, and recesses are formed to the extent of about 10 to 100 μm.

In punching, the dimensional precision of the silicon steel sheet in the plane direction is limited by the dimensional precision of the die. The silicon steel sheet is usually sheared with a clearance equal to about 5% of the thickness of the silicon steel sheet, so the dimensional precision of the silicon steel sheet in the plane direction is lowered. There is another problem; since the die is worn down during mass production, its precision is lowered with time. In addition, the thinner the silicon steel sheet is, the harder punching is.

In this embodiment in which etching is applied, these problems are solved and precision is not reduced with time.

When a prescribed pattern is used to have the shape of the stator core exposed, a mark or reference hole related to the direction in which rolling is performed on the electromagnetic steel sheet is preferably provided.

When electromagnetic steel sheets are laminated, it is necessary to average them in the rolling direction to improve the characteristics of the spindle motor. For example, suppose that marks or reference holes are displaced by a prescribed amount in the rolling direction when electromagnetic steel sheets are laminated. If the marks or reference holes are aligned, the magnetic characteristics of the spindle motor can be improved.

When a spindle motor is implemented by using the above thin electromagnetic steel sheets fabricated in an etching method, its cogging torque and iron loss of are low and its precision and efficiency is high.

An HDD equipped with the inventive spindle motor generates sufficiently low cogging torque, so variations in the rotational speed of the disk 30 on which to record magnetic information can be reduced to an extremely low level, making recording and reproduction of the magnetic information stable and achieving high-speed operation, a large storage capacity, and high reliability.

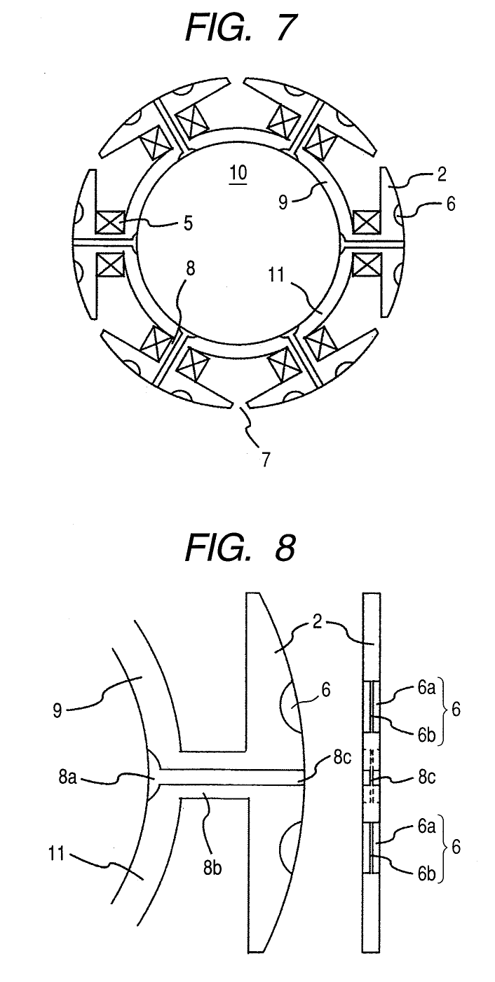

FIG. 7 shows the structure of the stator of the spindle motor in another embodiment of the present invention, and FIG. 8 is an enlarged view of the main part in the present invention. In these drawings, elements identical to elements in FIG. 1 are indicated by the same reference numerals. The rotor has the same structure as shown in FIG. 1.

The stator 10 comprises a stator core 11 and stator coils. The stator core 11 shown here comprises six salient poles 8 and a yoke 9 for forming a magnetic path. The stator core is fabricated by the etching method described above. The stator 10 in the present invention further includes grooves, each of which comprises an etched part 8a and etched part 8b and extends from the salient pole 8 of the stator core 11 to the yoke 9. A part remaining after etching constitutes a salient pole bridge 8c that has a role for integration to prevent the entire structure from being broken down into individual elements. The etched parts 8a and 8b are structured so that an adhesive is embedded therein.

The compensation groove 6 comprises etched parts 6a formed on both sides of the electromagnetic steel sheet and an auxiliary groove bridge 6b left in the processing by the etching method. The shape of the compensation groove 6, which is determined by a width, a depth, and the like, is selected so that the compensation groove 6 has almost the same magnetic permeance as the slit 7.

Unlike thick sheets, the thin electromagnetic steel sheet has no stiffness, so it is filmsy like paper.

To have the thin electromagnetic steel sheet have stiffness, an adhesive (not shown) is supplied into the etched parts 8a, 8b, and 6a, improving assembling precision. The groove, which is formed by the etched parts 8a and 8b extending from the salient pole 8 to the yoke 9, shields the magnetic flux in the peripheral direction, so the magnetic flux of the salient pole 8 can be created only by the component in the radial direction, reducing the iron loss. Accordingly, the spindle motor can be used in high-speed applications.

The above adhesive can also bond the laminated thin electromagnetic steel sheets, so the process of fixing adjacent thin electromagnetic steel sheets by using hooks can be eliminated. This prevents a magnetic linkage from being formed, so a stator core having a further low iron loss can be provided. The above etched parts are not limited to the shapes and locations shown in the drawings. For example, circular etched parts may be provided at the center of the ring-shaped yoke. Another etched part may be provided around the outer periphery of the salient pole. It is also possible to partially expand or deepen the etched part. For example, the etched part may be shaped so that part of the etched part in the auxiliary groove is deleted from both sides so as to eliminate the auxiliary groove bridge in the lamination direction.

With the spindle motor structured as described above, the iron loss can be reduced by the use of thin sheets, an increase in iron loss due to punching can be avoided, an increase in iron loss due to an electric short by hooks used to fix laminated core can be avoided, and the iron loss can be reduced by reducing components of the magnetic flux of the salient pole in the peripheral direction. As a result, the iron loss can be significantly reduced.

When the spindle motor is designed for an HDD, high-speed driving is achieved and a large amount of information can be recorded. In addition, since the spindle motor consumes less power, a battery usage time between battery charges can be prolonged, making the spindle motor suitable for mobile applications.

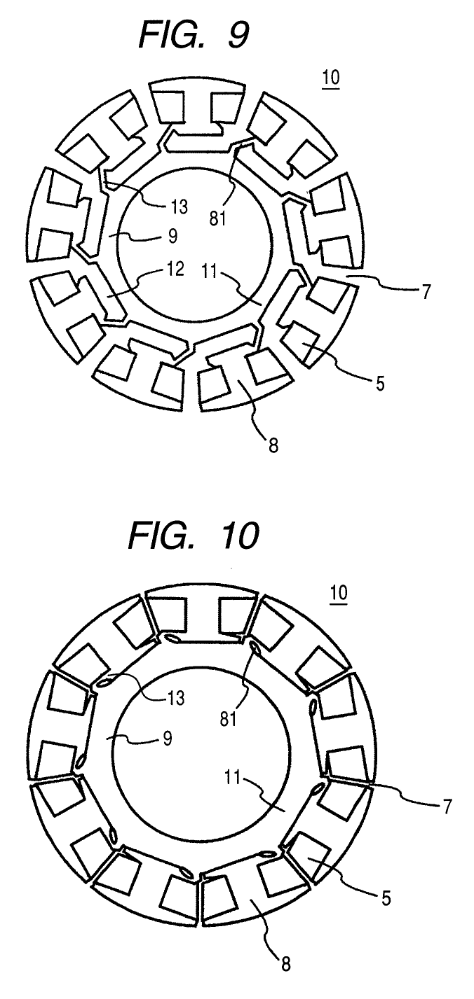

FIGS. 9 and 10 show the structure of the stator of the spindle motor in yet another embodiment of the present invention.

This embodiment in the present invention implements a structure of a concentrated winding stator core of an outer rotary type, as in the embodiment shown in FIG. 1.

As shown in FIG. 9, the stator has a stator core 11 on which a plurality of salient poles 8 are disposed radially on a yoke 9 and also includes status coils 5, each of which is wounded around one of the plurality of salient poles 8. The salient poles 8 are disposed in a loop with a slit 7 several millimeters in width intervening between adjacent salient poles.

The electromagnetic steel sheets described above are etched as shown in FIG. 9 so as to constitute the stator core 11. Specifically, the electromagnetic steel sheets of the stator core 11 are etched into the shape shown in FIG. 9 so that a deformation pressure absorbing clearance 12 is left between the yoke 9 and each salient pole 8, and magnetic pole retaining bridges 13 are provided to prevent the salient poles 8 from being separated apart. A side opposite to the bridge 13 is an open end, the angular parts of which are fitting ends. The fabricated steel sheets are laminated to a prescribed thickness, forming the stator core 11 shown in FIG. 9.

A winding process is then performed to form stator coils 5. In this state, the slit 7 between salient poles 8 has a width that allows the nozzle of a winding machine to sufficiently move, so a concentrated winding is efficiently formed speedily with a margin.

The inner diameter and outer diameter of the winding part of the stator core 11 are larger by the amount of the deformation pressure absorbing clearance 12, so the cross section of the spacing in which to form the stator coil 5 can be enlarged, and the slit 7, which is an opening of the stator coil spacing, is widened by the amount by which the outer diameter is increased. Accordingly, the number of turns of the winding of the stator coil 5 or the diameter of the winding can be increased by the amount by which the cross section of the spacing in which winding is possible is enlarged.

The stator core 11 in which the stator coils 5 have been formed is compressed from the outer peripheral direction and deformed up to a prescribed outer diameter, that is, compressed and deformed until the deformation pressure absorbing clearance 12 is completely eliminated. The magnetic pole retaining bridge 13 then causes plastic deformation along the bottom of the stator coil 5, and the ends on the inner diameter side of the salient pole 8 firmly fit to the fitting ends of the opening ends, creating a strong linkage. Although the spacing compressed due to the above plastic deformation should be completely eliminated as described above, in view of the ease of the plastic deformation or spring-back during the plastic deformation, a clearance (spacing on the inner peripheral side of the salient pole in FIG. 10) for the plastic deformation is preferably provided in the magnetic pole retaining bridges 13 in advance. The plastic deformation then occurs precisely.

It should be noticed that when the salient poles 8 are concentrically compressed and deformed, coil damage is avoided and the compression spacing is eliminated, minimizing the magnetic loss.

When the above structure is implemented, the iron loss can be significantly reduced by, for example, using thin sheets to reduce the iron loss and employing an etching method to avoid an increase in iron loss that would otherwise be brought by punching. In addition, the spacing occupied by the stator coil 5 can be increased, enabling the winding resistance to be lowered. Accordingly, the efficiency of the spindle motor can be further increased. Furthermore, in the present invention, the width of the slit, by which cogging torque is generated, can be reduced, so even if there is no auxiliary groove, as shown in the drawing, the cogging torque can be sufficiently reduced and the mechanical strength and the torque can be increased.

When the spindle motor is designed for an HDD, high-speed driving is achieved and a large amount of information can be recorded at high speed. In addition, since the spindle motor consumes less power, a battery usage time between battery charges can be prolonged, making the spindle motor suitable for mobile applications.

What is claimed is:

1. A spindle motor having a stator and a rotor, the stator having a stator core including salient poles as well as stator coil wound onto each salient pole, the stator core being formed by laminated steel sheets, wherein:
the salient pole made of the steel sheets is formed by etching; and
the steel sheet is 0.05 to 0.30 mm thick.

2. The spindle motor according to claim 1, wherein the steel sheet is an electromagnetic steel sheet that includes 0.001 to 0.060 wt % of C, 0.1 to 0.6 wt % of Mn, 0.03 wt % or less of P, 0.03 wt % or less of S, 0.1 wt % or less of Cr, 0.8 wt % or less of Al, 0.5 to 7.0 wt % of Si, and 0.01 to 0.20 wt % of Cu, and a residual including Fe and indispensable impurities.

3. The spindle motor according to claim 1, wherein the steel sheet is a silicon steel sheet.

4. The spindle motor according to claim 1, wherein the steel sheet has crystal particles.

5. The spindle motor according to claim 1, wherein the stator core has an insulative film with a thickness of 0.01 to 0.2 μm between laminated steel sheets.

6. The spindle motor according to claim 1, wherein the stator core has an insulative film with a thickness of 0.1 to 0.2 μm between laminated steel sheets.

7. The spindle motor according to claim 6, wherein the insulative film is made of an organic material, an inorganic material, or a mixture thereof.

8. The spindle motor according to claim 1, wherein the stator core has an insulative film with a thickness of 0.01 to 0.05 μm between laminated steel sheets.

9. The spindle motor according to claim 6, wherein the insulative film is an oxide film.

10. The spindle motor according to claim 3, wherein the concentration of silicon in the silicon steel sheet is 0.8 to 2.0 wt %.

11. The spindle motor according to claim 3, wherein the concentration of silicon in the silicon steel sheet is 4.5 to 6.5 wt %.

12. The spindle motor according to claim 3, wherein the concentration of silicon in the silicon steel sheet is higher at a surface than in an interior.

13. The spindle motor according to claim 1, wherein grooves are provided at two or more positions near the center of each salient pole out of positions corresponding to mechanical angles of (360/L)×(2n+1)/2 relative to the center of a slit between ends of the adjacent salient poles, where n is an integer and L is the least common multiple of the number M of poles of the rotor and the number S of poles of the stator.

14. The spindle motor according to claim 1, wherein the stator core has an etched part on part of a surface of the stator core in a thickness direction, so that the thickness of the etched part becomes thinner than another part of the stator core.

15. The spindle motor according to claim 14, wherein the etched part is filled with resin.

16. A disk drive that uses the spindle motor cited in claim 1.

17. A spindle motor having a stator and a rotor, the stator having a stator core including salient poles as well as stator coil wound onto each salient pole, the stator core being formed by laminated steel sheets, wherein:
the steel sheet is 0.05 to 0.30 mm thick; and
a laminated core concentration (%) is 90.0% to 99.9%, the laminated core concentration being defined to be “thickness (mm) of steel sheet×number of sheets÷height of core (mm)×100”.

18. The spindle motor according to claim 17, wherein the stator core made of the steel sheets is formed by an etching process; in the etching process, a resist is applied to the steel sheet, the shape of the stator core is exposed and developed, the resist is removed according to the shape, processing is performed by use of an etching liquid, and the remaining resist is removed.

19. A method of fabricating a stator core, comprising the steps of:
forming a laminated stator core in which a plurality of salient poles are disposed in the shape of a loop by means of magnetic pole retaining bridges disposed inner periphery of the salient poles;
forming a stator coil in each of the salient poles; and
compressing and deforming the stator core to a prescribed outside dimension, from outer peripheral directions.

20. The method of fabricating a stator core according to claim 19, wherein a deformation pressure absorbing clearance is provided at a root of the salient pole to absorb deformation of the magnetic pole retaining bridge.
